(19) United States
(12) Patent Application Publication
(10) Pub. No.: US 2002/0130077 A1
(43) Pub. Date: Sep. 19, 2002

(54) Separation of azeotropic mixtures

(76) Inventors: Wolfram Burst, Mannheim (DE); Gerd Kaibel, Lampertheim (DE); Thomas Kuntze, Boehl-Iggelheim (DE); Josef Konig, Zellertal (DE)

Correspondence Address: KEIL & WEINKAUF, 1350 CONNECTICUT AVENUE, N.W., WASHINGTON, DC, 20036, US

(21) Appl. No.: 10/041,558

(22) Filed: Jan. 10, 2002

(30) Foreign Application Priority Data
Jan. 17, 2001 (DE) 10101942.4

(51) Int. Cl. B01D 11/00

(52) U.S. Cl. 210/634; 210/774; 210/805

(57) ABSTRACT

A process for separating a liquid mixture of at least two components A and B which form an azeotrope with one another, optionally together with further components, comprises (i) distilling the mixture to be separated in the presence of an auxiliary H which with each of the two components A and B forms a binary azeotrope AH or BH which has a boiling point lower than that of H, and (ii) isolating an A,H-containing fraction which is depleted in B compared to the mixture to be separated and a B,H-containing fraction which is depleted in A compared to the mixture to be separated.

The present invention relates to a process for separating a liquid mixture of at least two components which form an azeotrope with one another.

Liquid mixtures consisting of two or more components frequently occur in chemical processes. Separation of these mixtures is employed, for example, for upgrading raw materials, for the further processing of intermediates, for the isolation of desired products, etc. A classical separation process is distillation or rectification. However, components which form an azeotrope with one another cannot be separated from one another by simple distillation or rectification, since liquid and vapor have the same composition at the azeotropic point.

Various methods of separating azeotropic mixtures are described in the prior art. A comprehensive summary may be found, for example, in E.-U. Schlunder and F. Thurner in “Destillation, Absorption, Extraktion”, Thieme Verlag, Stuttgart, 1986.

In two-pressure rectification, use is made of the fact that the position of the azeotropic point is generally pressure-dependent and two columns are operated at different pressures. Rectification of a mixture comprising the components A, B in the first column effects separation into the less volatile component B as bottom product and an azeotrope (AB) as top product which is transferred to the second column. Increasing or decreasing the pressure in the second column shifts the azeotropic point so as to give the pure component A as residue and an azeotrope (AB) which is returned to the first column.

Heteroazeotropic rectification makes it possible to separate mixtures of two components whose azeotrope has a composition within a miscibility gap of the components. In a first column, the mixture is firstly separated into the less volatile component B as bottom product and a mixture of virtually azeotropic composition as top product. On condensation, the top product separates into two phases in a phase separation vessel owing to the miscibility gap. The low-A phase is returned to the first column. The A-rich phase is passed to a second column which is operated at the same pressure as the first column and in which the component A is obtained as bottom product. The azeotrope taken off at the top is, after condensation, likewise recirculated to the phase separation vessel.

In extractive rectification, use is made of a relatively nonvolatile auxiliary which selectively binds one of the components of the mixture and thus changes the relative volatility of the mixture.

Similarly, azeotropic rectification is rectification carried out with the aid of an auxiliary, but in contrast to extractive rectification the boiling point of the auxiliary is little different from that of the components of the mixture. The auxiliary results in formation of a low-boiling three-component azeotrope, so that distillation in a first column makes it possible to obtain the pure component A as bottom product and the azeotropic three-component mixture as top product. The latter separates, after condensation, into an auxiliary-rich phase which is returned to the first column and a phase depleted in the auxiliary. The phase depleted in the auxiliary can be separated by further rectification into the ternary azeotrope as top product, which is condensed and returned to the phase separator, and a binary mixture of A and B as bottom product. The latter can be separated in a third separation column to give B as bottom product and the binary azeotrope AB as top product.

For particular separation tasks, for instance the separation of chlorinated hydrocarbons and C₃-C₈-alkanols, the known processes are of only limited practical use. Thus, the decomposition of chlorinated hydrocarbons to form hydrogen chloride leads to considerable corrosion problems in the two-pressure distillation. Furthermore, temperature-dependent substances restrict the choice of distillation temperatures.

It is an object of the present invention to provide a further process for the separation of azeotropic mixtures which is, in particular, economical and simple in process engineering terms.

We have found that this object is achieved by a process for separating a liquid mixture of at least two components A and B which form an azeotrope with one another, optionally together with further components, which comprises

i) distilling the mixture to be separated in the presence of an auxiliary H which with each of the two components A and B forms a binary azeotrope AH or BH which has a boiling point lower than that of H, and

ii) isolating an A,H-containing fraction which is depleted in B compared to the mixture to be separated and a B,H-containing fraction which is depleted in A compared to the mixture to be separated.

The mixture to be separated comprises at least two components A and B which form an azeotrope with one another. The process of the present invention is particularly advantageous when the azeotrope AB is not a heteroazeotrope, i.e. when the components A and B are either completely miscible with one another or the composition of the azeotrope AB lies outside a miscibility gap of A and B. In addition to the components A and B, the mixture to be separated may further comprise additional components C, etc. The further components can form further azeotropes with A and/or B.

The auxiliary H has to form a binary azeotrope AH or BH having a boiling point lower than that of H with each of the two components A and B. The azeotropes AH and BH have different boiling points at least at the pressure selected for the distillation. The A,H-containing fraction and the B,H-containing fraction can be obtained either in gaseous form, e.g. as gaseous product at the top of a column or in liquid form, e.g. as liquid fraction taken off at a side offtake of a column. A fraction obtained in gaseous form generally has approximately the composition of the azeotrope AH or BH; the composition of a fraction obtained in liquid form can differ from the composition of the azeotrope; however, it is generally coexistent with the gaseous azeotrope according to the phase diagram. In this way, an A,H-containing fraction which is depleted in B compared to the mixture to be separated is obtained as low-boiling fraction and a B,H-containing fraction which is depleted in A compared to the mixture to be separated is obtained as intermediate-boiling fraction, or vice versa, and a fraction consisting essentially of H is usually obtained as high-boiling fraction. The terms “low-boiling”, “intermediate-boiling” or “high-boiling” refer only to the relative volatility of the fractions concerned. It is of course possible, particularly when the mixture to be separated contains further components, to obtain further fractions whose volatility may be higher than, lower than or between that of the abovementioned fractions.

In many cases, one component, e.g. the component A, is immiscible or only very slightly miscible with the auxiliary (i.e. the solubility of the component in H is, for example, less than 5 g/l), while the other component, e.g. the component B, is completely miscible or miscible over a wide range with the auxiliary (i.e. the solubility of the component in H is, for example, more than 100 g/l). If the mixture to be separated further comprises additional components, these can be isolated in pure form, in admixture with one another, possibly together with the azeotrope A,H or B,H, or as azeotrope with H, depending on the individual case.

Surprisingly, the process of the present invention can also be carried out successfully when the auxiliary H is able to form a ternary azeotrope with the components A and B.

The process of the present invention is particularly useful for separating a mixture which comprises a first component selected from among chlorinated hydrocarbons, preferably those having a molar mass of at least 84 g/mol, and monocyclic C₆-C₁₀-aromatics and a second component selected from among C₃-C₈-alkanols. In these cases, water serves as auxiliary. Suitable C₃-C₈-alkanols include n-propanol, isopropanol, n-butanol, sec-butanol, i-butanol, n-hexanol, cyclohexanol and octanol. Suitable monocyclic C₆-C₁₀-aromatics include benzene, toluene and the xylenes. Preferred examples of chlorinated hydrocarbons are butyl chloride, methylene chloride, trichloromethane, tetrachloromethane, dichloroethane, trichloroethylene and perchloroethylene.

The process is particularly suitable for separating a mixture of perchloroethylene and n-butanol, optionally together with butyl chloride. Such a mixture is obtained, for example, in a process for preparing L-ascorbic acid in which butyl 2-keto-L-gulonate is lactonized in perchloroethylene as solvent.

If the mixture to be separated contains chlorinated hydrocarbons, the water as auxiliary is advantageously admixed with a base to prevent corrosion. The pH of the water is set to a value in the range from 7.5 to 12, preferably from 8.5 to 10.5. Examples of suitable bases are alkali metal hydroxides and alkaline earth metal hydroxides, e.g. sodium hydroxide, potassium hydroxide, magnesium hydroxide or calcium hydroxide, preferably sodium hydroxide, alkali metal carbonates and alkaline earth metal carbonates, e.g. sodium carbonate, potassium carbonate, magnesium carbonate or calcium carbonate, and alkali metal hydrogencarbonates, e.g. sodium hydrogencarbonate or potassium hydrogencarbonate.

The process of the present invention can be carried out batchwise or continuously. When it is carried out batchwise, the mixture to be separated is admixed with the auxiliary and distilled. In this case, the total amount of the auxiliary can be added at the beginning of the distillation or the auxiliary can be continually or periodically supplemented during the distillation. Condensation of the vapor gives the A,H-containing fraction and the B,H-containing fraction one after the other. However, this is uneconomical for the separation of large amounts of the mixture to be separated or a mixture which arises continually.

In a preferred embodiment of the process, the mixture to be separated is fed continuously into the column for the distillation. Columns suitable for the separation are well known to those skilled in the art. To increase mutual contact between the ascending vapor and descending liquid, the column contains customary internals. These include internals such as structured packing, random packing elements, for example Raschig rings, Pall rings, saddles or spheres, or trays, for example sieve trays, bubble cap trays, tunnel trays or valve trays or trays having a similar structure. Preference is given to using bubble cap trays or tunnel trays. The size of the column depends on the respective throughputs.

It is advantageous to feed at least part of the auxiliary into the column together with the mixture to be separated. A preferred embodiment of the invention comprises, as an alternative or in addition to the above, introducing at least part of the auxiliary H at the top and/or in the upper region, i.e. above the point of introduction of the mixture to be separated, of the column, preferably above the offtake for the low-boiling, A,H-containing fraction. The vapor rising through the column and the descending auxiliary are in this way conveyed in countercurrent. This method of operating the process makes it possible to reduce or prevent formation of a ternary azeotrope ABH which has a boiling point lower than those of the binary azeotropes AH and BH and whose occurrence could adversely affect the success of the separation.

The A,H-containing fraction and the B,H-containing fraction are appropriately obtained at side offtakes, with the lower-boiling fraction also being able to be taken off at the top if the mixture to be separated contains no further components having even lower boiling points.

The auxiliary H is normally obtained as bottom product. The auxiliary is advantageously conveyed from there back to the top and/or into the upper region of the column.

The mass flow of the auxiliary H introduced at the top or in the upper region of the column is usually from 0.5 to 15 times the mass flow of the mixture to be separated, based on the part different from H, preferably from 3 to 9 times, in particular from 4 to 8 times and very particularly preferably from 4 to 6.5 times, the mass flow of the mixture to be separated.

In a preferred embodiment, the mixture to be separated is fed in at the side of the column at a point between the bottom and the top, and the A,H-containing fraction is taken off at a point above the point of introduction of the mixture to be separated and the B,H-containing fraction is taken off at a point below the point of introduction of the mixture to be separated. In such an embodiment, the lower-boiling A,H-containing fraction is stripped out in the lower part of the column which functions as a stripping column and its concentration is increased in the upper part of the column which functions as enrichment column.

The auxiliary H advantageously forms a heteroazeotrope with the pure component A and/or the pure component B, preferably with both, i.e. the composition of the azeotrope AH or the azeotrope BH is located in a miscibility gap of the component A or B with the auxiliary. In this case, the A,H-containing fraction or the B,H-containing fraction separates into two phases on condensation. Phase separation gives an A-rich or B-rich phase and an H-rich phase, and the latter is advantageously fed back into the column. In the most favorable case, the purity of the A-rich or B-rich phase is so high that the component A or B can be used without further purification. Otherwise, the A-rich or B-rich phase can be subjected to further separation processes, e.g. a further distillation, stripping process, extraction process, membrane separation process, etc.

Apparatuses suitable for the phase separation are those known from the prior art, for example gravity separators, centrifuges or hydrocyclones. Preference is given to using decanters.

In the embodiment of the invention in which the mixture to be separated is a mixture of perchloroethylene and n-butanol, optionally together with butyl chloride, and is separated with the aid of water as auxiliary, the following heteroazeotropes occur (in order of decreasing boiling points): n-butanol/water, perchloroethylene/water and, if butyl chloride is present, butyl chloride/water. When the process is carried out in a column, it is therefore advantageous to take off an n-butanol/water fraction in liquid form at a side offtake in the lower region of the column, to take off a perchloroethylene/water fraction in liquid form at a side offtake in the upper region of the column and to take off a butyl chloride/water fraction as gaseous product at the top.

The n-butanol/water fraction is advantageously subject to a phase separation to give an n-butanol-rich phase and a water-rich phase, with the latter advantageously being returned to the column. The n-butanol phase may, if desired, be fractionally distilled in a second column to give a fraction enriched in n-butanol and a fraction depleted in n-butanol. The second column is preferably operated at the same pressure as the first column.

Owing to the pronounced miscibility gap of perchloroethylene and water, the perchloroethylene/water fraction separates into an aqueous phase which is advantageously returned to the column and a perchloroethylene phase of high purity, normally above 95% by weight, which is taken from the system.

Butyl chloride forms a heteroazeotrope with water. After condensation of the gaseous butyl chloride/water fraction and phase separation, the aqueous phase is fed back into the column. The butyl chloride phase can be taken from the system. The mixture to be separated may further comprise additional high-volatility components, for example acetone, which are likewise obtained in the top product. If these compounds are also soluble in water, it is advantageous to discharge part of the aqueous phase in order to prevent accumulation of the high-volatility components in the system.

The water used as auxiliary collects at the bottom of the column and a stream of this is taken off and introduced into the column at the top and/or in the upper region. This way of carrying out the process enables the formation of the ternary azeotrope butanol/perchloroethylene/water to be reduced or prevented.

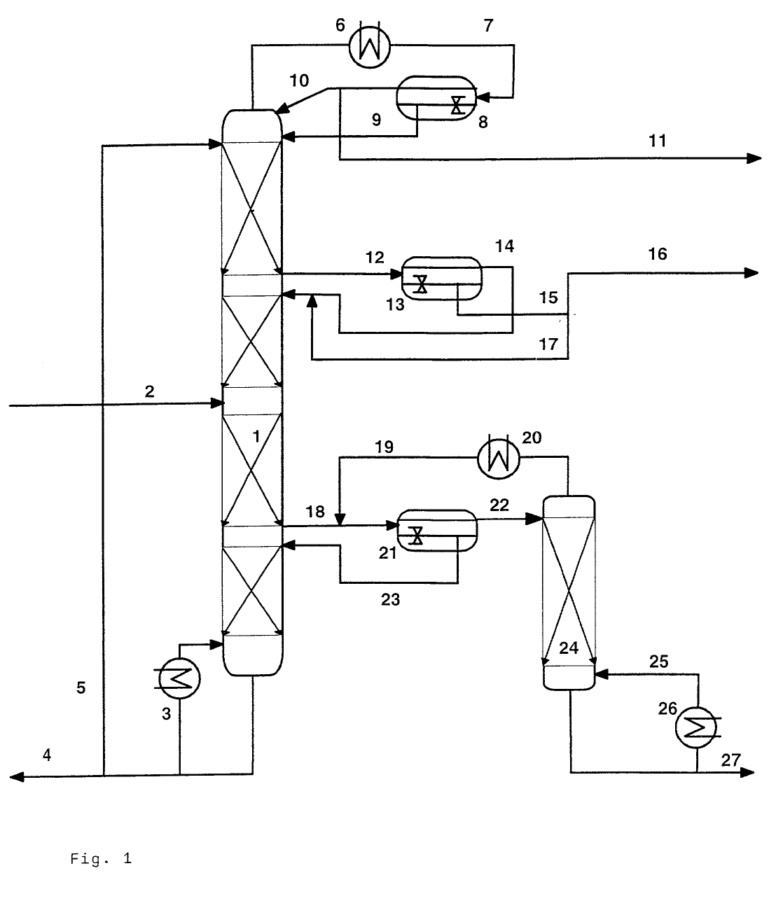

A plant suitable for carrying out the process of the present invention is shown in FIG. 1 and is explained below.

FIG. 1 schematically shows a plant suitable for carrying out the process of the present invention for, by way of example, separating a liquid mixture of n-butanol/perchloroethylene/butyl chloride with the aid of water as auxiliary. The mixture to be separated can, for example, consist of from about 10 to 80% by weight, in particular from 20 to 60% by weight, of 1-butanol, preferably from about 20 to 90% by weight, in particular from 40 to 80% by weight, of perchloroethylene and up to 50% by weight, in particular up to 20% by weight, of water.

In the process depicted in FIG. 1, the liquid mixture to be separated is fed continuously into the column (1) via line (2). Water is taken off from the bottom of the column (1), which is connected in a customary fashion to a vaporizer (3), and is subsequently conveyed via line (5) to the top of the column (1). Excess water can be removed from the column (1) via line (4). The bottoms usually contain less than 2% by weight, preferably less than 200 ppm, of 1-butanol.

A liquid perchloroethylene/water mixture which usually contains from about 5 to 30% by weight, preferably from 10 to 20% by weight, of perchloroethylene, less than 5% by weight, preferably less than 1% by weight, of 1-butanol and less than 5% by weight, preferably less than 2% by weight, of butyl chloride is taken off from the enrichment section of the column (1) via the side offtake (12). The mixture is passed to a phase separator (13). The aqueous phase is returned to the column (1) via line (14). The perchloroethylene phase obtained in the phase separator (13) is taken from the system via line (16). Depending on the desired product purity, a certain proportion of the perchloroethylene phase which has been separated off is conveyed via line (17) back into the column (1).

A mixture consisting essentially of 1-butanol and water is obtained at the side offtake (18) of the stripping section of the column (1). The butanol content of this mixture is usually from 2 to 25% by weight, preferably from 5 to 15% by weight. In addition, the mixture contains not more than 5% by weight, preferably not more than 1% by weight, of perchloroethylene and not more than 1% by weight, preferably not more than 0.5% by weight, of butyl chloride. The mixture is passed to a phase separator (21). The aqueous phase obtained in the phase separator (21) is conveyed via line (23) back to the column (1). The butanol phase is fed via line (22) to a second separation column (24) and is worked up there.

A gaseous phase which has approximately the concentration of the butyl chloride/water azeotrope is taken off from the top region of the column (1). The stream is condensed in the condenser (6) and passed to a phase separator (8) via line (7). The aqueous phase is returned to the column (1) via line (9). The aqueous phase still contains traces of perchloroethylene and less than 2% by weight, preferably less than 0.5% by weight, of 1-butanol. One part of the butyl chloride phase obtained in the phase separator (8) is taken from the system via line (11) and the other part is returned to the column (1) via line (10). The butyl chloride phase usually comprises at least 60% by weight, preferably at least 90% by weight and in particular at least 95% by weight, of butyl chloride.

Typical operating conditions for the first separation column (1) are: pressure at the top from about 0.1 bar to 2 bar, preferably from 0.8 bar to 1.2 bar, temperature at the top from about 5° C. to 105° C., preferably from 50° C. to 90° C., temperature at the bottom from about 45° C. to 130° C., preferably from 90° C. to 120° C. The column has from about 10 to 70 theoretical plates, preferably 10 from 15 to 60 theoretical plates and in particular from about 20 to 50 theoretical plates. The heat input into the bottom vaporizer naturally depends on the amount of water used (5) and on the amount and composition of the organic feed. A power of usually from 15 to 50 kW, preferably from 25 to 45 kW and in particular from 30 to 45 kW, is introduced per metric ton of water used and a power of usually from 90 to 200 kW, preferably from 100 to 150 kW and in particular from 105 to 120 kW, is introduced per metric ton of organic feed.

The n-butanol phase separated off in the phase separator (21) consists essentially of n-butanol and water. The proportion of water is usually from about 10 to 40% by weight, preferably from about 15 to 30% by weight. The butanol phase is fed via line (22) to the top of a second separation column (24). At the bottom of the column (24), which is connected in a customary fashion to a vaporizer (26) via line (25), n-butanol of high purity is taken off via line (27). The water content of the n-butanol is usually less than 0.1% by weight, preferably even below 200 ppm. The product taken from the top of the second separation column (24) is condensed in the condenser (20) and all of it is conveyed back to the phase separator (21) via line (19). It advantageously has an approximately azeotropic composition. The water content is in the range from 35 to 50% by weight, preferably in the range from 38 to 48% by weight, depending on the energy input into the column.

The second separation column (24) is preferably operated at the same pressure as the first separation column (1). However, the second separation column (24) can also be operated at a pressure higher than that in the first separation column in order to achieve an increase in the proportion of water at the top of the second column by means of the pressure dependence of the azeotrope. In this way, the discharge of butanol at the bottom of the column can be optimized. The pressure difference between the two columns is up to 2 bar, preferably up to 0.8 bar. The column (24) is operated at a temperature at the top of from 40° C. to 120° C., preferably from 55° C. to 100° C., and a temperature at the bottom of from 60° C. to 145° C., preferably from 110° C. to 130° C. The separation column (24) contains the above-described internals, preferably mesh packing. The size of the separation column (24) naturally depends on the respective throughputs. The column (24) has from 3 to 20 theoretical plates, preferably from 5 to 15 theoretical plates and in particular from 7 to 12 theoretical plates.

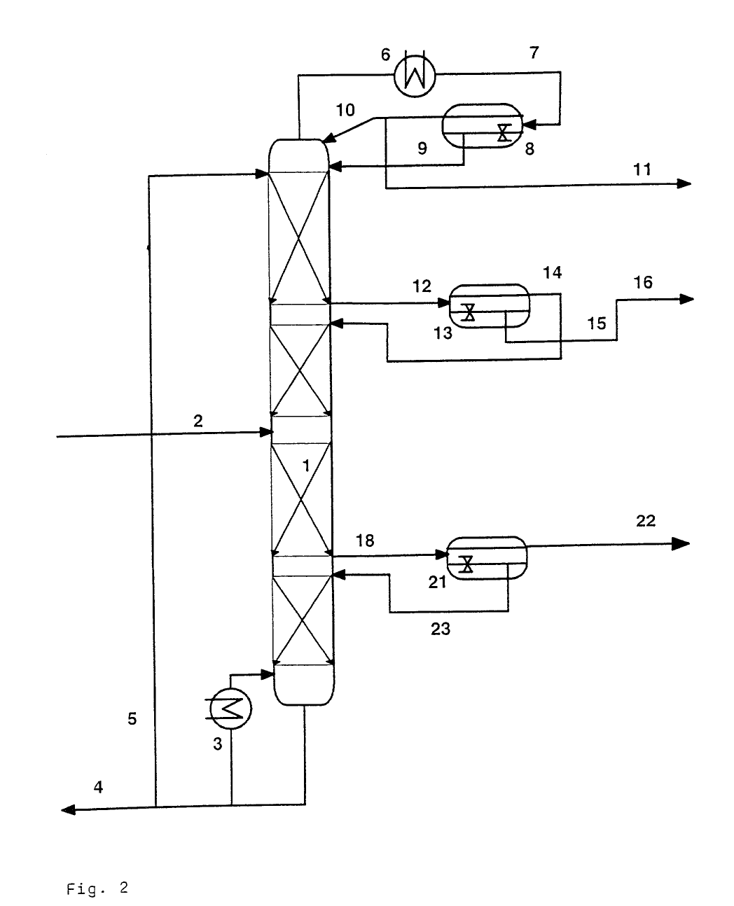

FIG. 2 likewise shows a plant for carrying out the process of the present invention. Identical reference numerals have the same meanings as in FIG. 1. Unlike FIG. 1, the n-butanol phase is not worked up by distillation in a second column. In addition, the recirculation of part of the perchloroethylene phase is dispensed with.

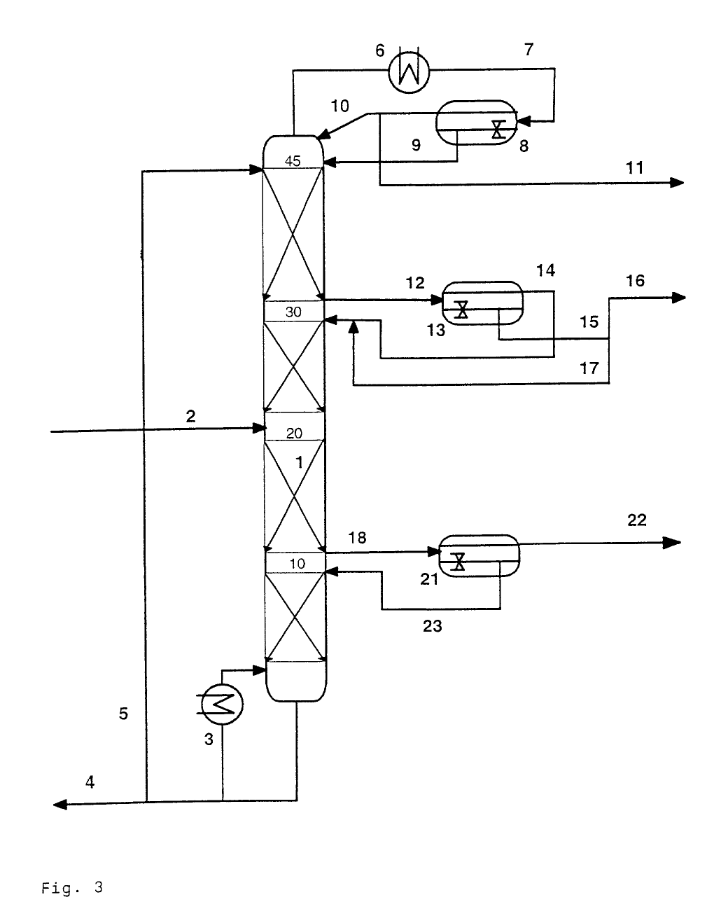

FIG. 3 shows a further plant for carrying out the process of the present invention. Identical reference numerals have the same meanings as in FIG. 1. Unlike FIG. 1, the work-up of the n-butanol phase by distillation in a second column is omitted.

The following examples illustrate the invention without restricting its scope.

### EXAMPLE 1

A plant as shown in FIG. 2 was used.

A liquid mixture consisting of 44% by weight of 1-butanol, 40.6% by weight of perchloroethylene, 14.2% by weight of water and 1.2% by weight of butyl chloride was fed to the column (1) via line (2). The composition of the individual streams is shown in Table 1.

The glass column (1) had a diameter of 43 mm, had 20 theoretical plates and was packed with mesh packing of the type CY from Sulzer Chemtech AG, Winterthur. The reflux ratio of the organic phase was 30. The column was operated at a pressure at the top of 1 bar. The temperature at the bottom was 104° C. and the temperature at the top was 69° C. The feed point (2) was about in the middle of the column above the 2nd packing element at theoretical plate 10. The recirculated stream (5) was fed back into the column above the top of the 4th packing element. The stream (18) was taken off in the middle of the lower column section (stripping section) from the bottom end of the 2nd packing element. The stream (12) was taken off in the middle of the upper column section (enrichment section) from the bottom of the uppermost packing element.

TABLE 1

| | Stream | Stream | Stream | Stream | Stream | Stream |
|---|---|---|---|---|---|---|
| | 2 | 11 | 16 | 22 | 4 | 5 |
| Mass flow (g/h) | 864.5 | 3.5 | 356 | 481 | 24 | 2978 |
| n-Butanol | 44 | — | 0.6 | 78.5 | 200 ppm | 200 ppm |
| (% by weight) | | | | | | |
| Perchloroethylene | 40.6 | 1 | 97.6 | 0.9 | — | — |
| (% by weight) | | | | | | |
| Water | 14.2 | 100 ppm | 200 ppm | 20.5 | 100 | 100 |
| (% by weight) | | | | | | |
| Butyl chloride | 1.2 | 99 | 1.8 | 0.1 | — | — |
| (% by weight) | | | | | | |

### EXAMPLE 2

A plant as shown in FIG. 3 was used.

A liquid mixture consisting of 44% by weight of 1-butanol, 40.6% by weight of perchloroethylene, 14.2% by weight of water and 1.2% by weight of butyl chloride was fed to the glass column (1) via line (2). The composition of the individual streams is shown in Table 2.

The glass column (1) had a diameter of 30 mm and was equipped with 45 bubble cap trays. The reflux ratio of the organic phase was 30. The column was operated at a pressure at the top of 1 bar. The temperature at the bottom was 101.5° C. and the temperature at the top was 68° C. The feed point (2) was about in the middle of the column at theoretical plate 20. The recirculated stream (5) was fed back into the column onto the uppermost tray.

TABLE 2

| | Stream | Stream | Stream | Stream | Stream | Stream | Stream |
|---|---|---|---|---|---|---|---|
| | 2 | 11 | 16 | 22 | 17 | 4 | 5 |
| Mass flow | 864.5 | 3.5 | 354 | 483 | 20 | 24 | 2978 |
| (g/h) | | | | | | | |
| n-Butanol | 44 | — | 0.3 | 78.5 | 0.3 | 200 | 200 |
| (% by | | | | | | ppm | ppm |
| weight) | | | | | | | |
| Perchloro- | 40.6 | 1 | 97.9 | 0.9 | 97.9 | — | — |
| ethylene | | | | | | | |
| (% by | | | | | | | |
| weight) | | | | | | | |
| Water | 14.2 | 100 ppm | 200 ppm | 20.5 | 200 ppm | 100 | 100 |
| (% by | | | | | | | |
| weight) | | | | | | | |
| Butyl | 1.2 | 99 | 1.8 | 0.1 | 1.8 | — | — |
| chloride | | | | | | | |
| (% by | | | | | | | |
| weight) | | | | | | | |

We claim:

1. A process for separating a liquid mixture of at least two components A and B which form an azeotrope with one another, optionally together with further components, which comprises
i) distilling the mixture to be separated in the presence of an auxiliary H which with each of the two components A and B forms a binary azeotrope AH or BH which has a boiling point lower than that of H, and
ii) isolating an A,H-containing fraction which is depleted in B compared to the mixture to be separated and a B,H-containing fraction which is depleted in A compared to the mixture to be separated.

2. A process as claimed in claim 1, wherein the auxiliary H is additionally able to form a ternary azeotrope with the components A and B.

3. A process as claimed in claim 1, wherein the mixture to be separated is introduced continuously into a column for the distillation.

4. A process as claimed in claim 3, wherein at least part of the auxiliary is introduced into the column together with the mixture to be separated.

5. A process as claimed in claim 3, wherein at least part of the auxiliary H is introduced at the top and/or in the upper region of the column.

6. A process as claimed in claim 5, wherein the auxiliary H is obtained as bottom product and is recirculated at least partly to the top and/or into the upper region of the column.

7. A process as claimed in claim 3, wherein the A,H-containing fraction is taken off at a point above the feed point for the mixture to be separated and the B,H-containing fraction is taken off at a point below the feed point for the mixture to be separated.

8. A process as claimed in claim 5, wherein the mass flow of the auxiliary H introduced is from 0.5 to 15 times the mass flow of the mixture to be separated, based on the part different from H.

9. A process as claimed in claim 1, wherein the binary azeotrope AH and/or BH is a heteroazeotrope.

10. A process as claimed in claim 9, wherein the liquid or liquefied A,H-containing and/or B,H-containing fraction is subjected to a phase separation to give an A-rich or B-rich phase and an H-rich phase and the H-rich phase is returned to the column.

11. A process as claimed in claim 1, wherein the mixture to be separated is a mixture comprising a first component selected from among chlorinated hydrocarbons and monocyclic C₆-C₁₀-aromatics and a second component selected from among C₃-C₈-alkanols and the auxiliary used is water.

12. A process as claimed in claim 11, wherein the chlorinated hydrocarbon is perchloroethylene and the alkanol is n-butanol and the mixture optionally further comprises butyl chloride.

13. A process as claimed in claim 12, wherein the liquefied n-butanol/water fraction is subjected to a phase separation to give an n-butanol-rich phase and a water-rich phase and the n-butanol-rich phase is separated by distillation into a fraction enriched in n-butanol and a fraction depleted in n-butanol.

14. A process as claimed in claim 12, wherein a fraction which comprises butyl chloride and water and is largely free of perchloroethylene and n-butanol is additionally obtained as lowest-boiling fraction.

15. A process as claimed in claim 11, wherein the auxiliary H further comprises a base.
